(19) United States
(12) Patent Application Publication
(10) Pub. No.: US 2019/0346390 A1
(43) Pub. Date: Nov. 14, 2019

(54) SURFACE APPLIED SENSORS

(71) Applicant: Vorbeck Materials Corp., Jessup, MD (US)

(72) Inventor: John S. LETTOW, Washington, DC (US)

(73) Assignee: Vorbeck Materials Corp., Jessup, MD (US)

(21) Appl. No.: 16/393,925

(22) Filed: Apr. 24, 2019

Related U.S. Application Data
(63) Continuation of application No. 15/502,861, filed on Mar. 3, 2017, now abandoned.

(51) Int. Cl. G01N 27/12; G01M 3/18; G01M 3/40; G01M 3/04

(52) U.S. Cl. CPC G01N 27/12; G01M 3/045; G01M 3/40; G01M 3/18

(57) ABSTRACT

In some embodiments, a Wheatstone bridge device and sensor array wrappings are provided herein. The Wheatstone bridge device comprises a first resistor positioned proximate to a surface of the substrate and comprising a conductive composition. The conductive composition comprises fully exfoliated single sheets of graphene and a polymer. The first resistor is configured to undergo a conductivity change as a result of binding to a target component. The fully exfoliated single sheets of graphene display no signature corresponding to graphite or graphite oxide in their X-ray diffraction pattern.

### CROSS-REFERENCE TO RELATED APPLICATIONS

This application is continuation of U.S. patent application Ser. No. 15/502,861 filed Mar. 3, 2017, which is a 371 filing of International Application No. PCT/US15/45078 filed Aug. 13, 2015, which claims priority to U.S. Provisional Application No. 62/037,101 filed Aug. 13, 2014, all of which are hereby incorporated by reference in their entirety.

### BACKGROUND

The present invention relates generally to the field of sensors, and more specifically to surface applied sensors. Industrial infrastructure equipment, such as pipes and tanks, are typically examined at discrete intervals and locations. For example, the integrity of pipes in water, oil, and gas distribution networks are typically not monitored (except for pressure) and visual inspections are infrequent. As a result, undetected oil and gas leaks as well as water main breaks are addressed only after service is lost or roadways and buildings are flooded. In the same vein, discrete monitoring of the environment near the equipment that is associated with, for example, geothermal, oil and gas development or aquifer management, can result in incomplete geo-physical data.

Continuous monitoring typically involves high costs and overcoming accessibility issues, e.g. in case of underground structures. Only for the most critical and economical applications, such as oil and gas exploration, extensive efforts have gone into the development and deployment of continuous monitoring systems (e.g., logging while drilling).

### BRIEF DESCRIPTION OF THE DRAWINGS

FIG. 1 is a block diagram illustrating an environment, in accordance with an embodiment of the present invention.

FIG. 2 illustrates deployment configurations of printed electronic devices, in accordance with an embodiment of the present invention.

FIG. 3 depicts a block diagram of components of a data processing system, in accordance with an embodiment of the present invention.

FIG. 4 depicts a microsensor, generally 400, in accordance with an embodiment of the present invention.

FIG. 5 depicts an environment, generally 500, in accordance with an embodiment of the present invention.

FIG. 6 depicts a portion of a sensor array, generally 600, in accordance with an embodiment of the present invention.

FIG. 7 depicts a portion of a sensor array, generally 700, in accordance with an embodiment of the present invention.

FIG. 8 depicts a portion of a sensor array, generally 800, in accordance with an embodiment of the present invention.

### DETAILED DESCRIPTION

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. As used herein, the term “about” denotes a range of ±1 for values of at least 1 and a range of ±0.5 for values less than 1.

Surfaces are the exterior or upper boundary of an object or body, such as the skin of animals and humans, or the exteriors or interiors of open or closed vessels. Surfaces can experience fluidic leaks, spills, and/or discharge of, for example, bodily fluids, chemicals, and/or gases. Surfaces can also undergo temperature changes. For example, leaks, spills, and/or discharges that are associated with vessels, which include, but are not limited to, pipes, vessels, tubes, tanks, hulls, liners, containers, drums, cylinders, tubs, basins, and vessels, may be hard to detect due to their accessibility and/or location. However, undetected leaks are typically addressed only after service is lost and/or the structural integrity of the vessel is compromised. Continuous monitoring may be difficult to implement due to cost and accessibility issues, e.g. in case of underground, submerged, and encased vessels. For example, in the case of oil exploration, measurements, such as electromagnetic (EM) imaging of formations, are difficult to perform continuously over the full length of a vessel, such as a well, and may be hindered by measurement geometry (signal attenuation due to presence of metal casing) and are not typically performed during production.

In the case of oil exploration, oil wells are typically borings into the earth that are designed to bring petroleum hydrocarbons to the surface. Oil wells can be created by drilling a whole 12 cm to 1 meter in diameter into the earth with a drilling rig that rotates a drill string with a bit attached. After the hole is drilled, sections of steel pipe (casing), slightly smaller in diameter than the borehole, are placed in the hole. Concrete may be place between the outside of the casing and the borehole. The casing provides structural integrity to the newly drilled wellbore, in addition to isolating potentially dangerous high pressure zones from each other and from the surface.

With these zones safely isolated and the formation protected by the casing, the well can be drilled deeper (into potentially more-unstable and violent formations) with a smaller bit, and also cased with a smaller size casing. Contemporary wells often have two to five sets of subsequently smaller hole sizes drilled inside one another, each cemented with casing

Aspects of the present invention seek to provide sensors having one or more functionalities for monitoring surfaces. Other aspects of the present invention seek to provide sensors, and/or sensor arrays for continuous and/or full-coverage monitoring of such vessels. Additional aspects of the present invention seek to provide sensors comprised of graphene-based compositions (compositions) having enhanced properties, such as electrical conductivity, thermal conductivity, and mechanical properties. Still other aspects of the present invention seek to provide printed sensors, printed connecting circuitry, printed antennas for data transmission, and/or printed sensor arrays that are printed with inks of different compositions. Another aspect of the present invention seeks to provide sensors having a composition comprised of graphene sheets and, optionally, at least one aromatic compound, wherein the composition is an ink and/or coating. An additional aspect of the present invention seeks to provide a sensor apparatus comprising a sensor that is applied to a surface.

An aspect of the present invention seeks to provide sensors for monitoring surface temperatures of, for example, vessels, humans, and/or animals. An aspect of the present invention seeks to provide sensors in the form of a tape or wrap that can be applied to or wrapped around surfaces, such as, vessels or body parts for monitoring. Another aspect of the present invention seeks to provide sensor arrays for providing sensor readings coordinated to provide information that is more complete and/or accurate than currently available. Other aspects of the present invention seek to provide sensors arrays that are configured as parallel and/or mesh arrays.

Graphene sheets may be made using any suitable method. For example, they may be obtained from graphite, graphite oxide, expandable graphite, expanded graphite, etc. They may be obtained by the physical exfoliation of graphite, by for example, peeling, grinding, or milling off graphene sheets. They may be made from inorganic precursors, such as silicon carbide. They may be made by chemical vapor deposition (such as by reacting a methane and hydrogen on a metal surface). They may be formed by the reduction of an alcohol, such ethanol, with a metal (such as an alkali metal like sodium) and the subsequent pyrolysis of the alkoxide product (such a method is reported in Nature Nanotechnology (2009), 4, 30-33). They may be made by the exfoliation of graphite in dispersions or exfoliation of graphite oxide in dispersions and the subsequently reducing the exfoliated graphite oxide. Graphene sheets may be made by the exfoliation of expandable graphite, followed by intercalation, and ultrasonication or other means of separating the intercalated sheets (see, for example, Nature Nanotechnology (2008), 3, 538-542). They may be made by the intercalation of graphite and the subsequent exfoliation of the product in suspension, thermally, etc.

Graphene sheets may be made from graphite oxide (also known as graphitic acid or graphene oxide). Graphite may be treated with oxidizing and/or intercalating agents and exfoliated. Graphite may also be treated with intercalating agents and electrochemically oxidized and exfoliated. Graphene sheets may be formed by ultrasonically exfoliating suspensions of graphite and/or graphite oxide in a liquid (which may contain surfactants and/or intercalants). Exfoliated graphite oxide dispersions or suspensions can be subsequently reduced to graphene sheets. Graphene sheets may also be formed by mechanical treatment (such as grinding or milling) to exfoliate graphite or graphite oxide (which would subsequently be reduced to graphene sheets).

Reduction of graphite oxide to graphene may be by means of chemical reduction and may be carried out on graphite oxide in a dry form, in a dispersion, etc. Examples of useful chemical reducing agents include, but are not limited to, hydrazines (such as hydrazine, N, N-dimethylhydrazine, etc.), sodium borohydride, citric acid, hydroquinone, isocyanates (such as phenyl isocyanate), hydrogen, hydrogen plasma, etc. A dispersion or suspension of exfoliated graphite oxide in a carrier (such as water, organic solvents, or a mixture of solvents) can be made using any suitable method (such as ultrasonication and/or mechanical grinding or milling) and reduced to graphene sheets.

Graphite oxide may be produced by any method known in the art, such as by a process that involves oxidation of graphite using one or more chemical oxidizing agents and, optionally, intercalating agents such as sulfuric acid. Examples of oxidizing agents include nitric acid, nitrates (such as sodium and potassium nitrates), perchlorates, potassium chlorate, sodium chlorate, chromic acid, potassium chromate, sodium chromate, potassium dichromate, sodium dichromate, hydrogen peroxide, sodium and potassium permanganates, phosphoric acid (H₃PO₄), phosphorus pentoxide, bisulfites, etc. Preferred oxidants include KClO₄; HNO₃ and KClO₃; KMnO₄ and/or NaMnO₄; KMnO₄ and NaNO₃; K₂S₂O₈ and P₂O₅ and KMnO₄; KMnO₄ and HNO₃; and HNO₃. Preferred intercalation agents include sulfuric acid. Graphite may also be treated with intercalating agents and electrochemically oxidized. Examples of methods of making graphite oxide include those described by Staudenmaier (Ber. Stsch. Chem. Ges. (1898), 31, 1481) and Hummers (J. Am. Chem. Soc. (1958), 80, 1339).

One example of a method for the preparation of graphene sheets is to oxidize graphite to graphite oxide, which is then thermally exfoliated to form graphene sheets (also known as thermally exfoliated graphite oxide), as described in US 2007/0092432, the disclosure of which is hereby incorporated herein by reference. The thusly formed graphene sheets may display little or no signature corresponding to graphite or graphite oxide in their X-ray diffraction pattern. The thermal exfoliation may be carried out in a continuous, semi-continuous batch, etc. process.

Heating can be done in a batch process or a continuous process and can be done under a variety of atmospheres, including inert and reducing atmospheres (such as nitrogen, argon, and/or hydrogen atmospheres). Heating times can range from under a few seconds or several hours or more, depending on the temperatures used and the characteristics desired in the final thermally exfoliated graphite oxide. Heating can be done in any appropriate vessel, such as a fused silica, mineral, metal, carbon (such as graphite), ceramic, etc. Heating may be done using a flash lamp or with microwaves. During heating, the graphite oxide may be contained in an essentially constant location in single batch reaction vessel, or may be transported through one or more vessels during the reaction in a continuous or batch mode. Heating may be done using any suitable means, including the use of furnaces and infrared heaters.

Examples of temperatures at which the thermal exfoliation and/or reduction of graphite oxide can be carried out are at least about 150° C., at least about 200° C., at least about 300° C., at least about 400° C., at least about 450° C., at least about 500° C., at least about 600° C., at least about 700° C., at least about 750° C., at least about 800° C., at least about 850° C., at least about 900° C., at least about 950° C., at least about 1000° C., at least about 1100° C., at least about 1500° C., at least about 2000° C., and at least about 2500° C. Preferred ranges include between about 750 about and 3000° C., between about 850 and 2500° C., between about 950 and about 2500° C., between about 950 and about 1500° C., between about 750 about and 3100° C., between about 850 and 2500° C., or between about 950 and about 2500° C.

The time of heating can range from less than a second to many minutes. For example, the time of heating can be less than about 0.5 seconds, less than about 1 second, less than about 5 seconds, less than about 10 seconds, less than about 20 seconds, less than about 30 seconds, or less than about 1 min. The time of heating can be at least about 1 minute, at least about 2 minutes, at least about 5 minutes, at least about 15 minutes, at least about 30 minutes, at least about 45 minutes, at least about 60 minutes, at least about 90 minutes, at least about 120 minutes, at least about 150 minutes, at least about 240 minutes, from about 0.01 seconds to about 240 minutes, from about 0.5 seconds to about 240 minutes, from about 1 second to about 240 minutes, from about 1 minute to about 240 minutes, from about 0.01 seconds to about 60 minutes, from about 0.5 seconds to about 60 minutes, from about 1 second to about 60 minutes, from about 1 minute to about 60 minutes, from about 0.01 seconds to about 10 minutes, from about 0.5 seconds to about 10 minutes, from about 1 second to about 10 minutes, from about 1 minute to about 10 minutes, from about 0.01 seconds to about 1 minute, from about 0.5 seconds to about 1 minute, from about 1 second to about 1 minute, no more than about 600 minutes, no more than about 450 minutes, no more than about 300 minutes, no more than about 180 minutes, no more than about 120 minutes, no more than about 90 minutes, no more than about 60 minutes, no more than about 30 minutes, no more than about 15 minutes, no more than about 10 minutes, no more than about 5 minutes, no more than about 1 minute, no more than about 30 seconds, no more than about 10 seconds, or no more than about 1 second. During the course of heating, the temperature may vary.

Examples of the rate of heating include at least about 120° C./min, at least about 200° C./min, at least about 300° C./min, at least about 400° C./min, at least about 600° C./min, at least about 800° C./min, at least about 1000° C./min, at least about 1200° C./min, at least about 1500° C./min, at least about 1800° C./min, and at least about 2000° C./min.

Graphene sheets may be annealed or reduced to graphene sheets having higher carbon to oxygen ratios by heating under reducing atmospheric conditions (e.g., in systems purged with inert gases or hydrogen). Reduction/annealing temperatures are preferably at least about 300° C., or at least about 350° C., or at least about 400° C., or at least about 500° C., or at least about 600° C., or at least about 750° C., or at least about 850° C., or at least about 950° C., or at least about 1000° C. The temperature used may be, for example, between about 750 about and 3000° C., or between about 850 and 2500° C., or between about 950 and about 2500° C.

The time of heating can be for example, at least about 1 second, or at least about 10 second, or at least about 1 minute, or at least about 2 minutes, or at least about 5 minutes. In some embodiments, the heating time will be at least about 15 minutes, or about 30 minutes, or about 45 minutes, or about 60 minutes, or about 90 minutes, or about 120 minutes, or about 150 minutes. During the course of annealing/reduction, the temperature may vary within these ranges.

The heating may be done under a variety of conditions, including in an inert atmosphere (such as argon or nitrogen) or a reducing atmosphere, such as hydrogen (including hydrogen diluted in an inert gas such as argon or nitrogen), or under vacuum. The heating may be done in any appropriate vessel, such as a fused silica or a mineral or ceramic vessel or a metal vessel. The materials being heated including any starting materials and any products or intermediates) may be contained in an essentially constant location in single batch reaction vessel, or may be transported through one or more vessels during the reaction in a continuous or batch reaction. Heating may be done using any suitable means, including the use of furnaces and infrared heaters.

The graphene sheets preferably have a surface area of at least about 100 m²/g to, or of at least about 200 m²/g, or of at least about 300 m²/g, or of least about 350 m²/g, or of least about 400 m²/g, or of least about 500 m²/g, or of least about 600 m²/g, or of least about 700 m²/g, or of least about 800 m²/g, or of least about 900 m²/g, or of least about 700 m²/g. The surface area may be about 400 to about 1100 m²/g. The theoretical maximum surface area can be calculated to be 2630 m²/g. The surface area includes all values and subvalues there between, especially including 400, 500, 600, 700, 800, 900, 1000, 1100, 1200, 1300, 1400, 1500, 1600, 1700, 1800, 1900, 2000, 2100, 2200, 2300, 2400, 2500, and 2630 m²/g.

The graphene sheets can have number average aspect ratios of about 100 to about 100,000, or of about 100 to about 50,000, or of about 100 to about 25,000, or of about 100 to about 10,000 (where “aspect ratio” is defined as the ratio of the longest dimension of the sheet to the shortest). Surface area can be measured using either the nitrogen adsorption/BET method at 77 K or a methylene blue (MB) dye method in liquid solution.

The dye method is carried out as follows: A known amount of graphene sheets is added to a flask. At least 1.5 g of MB are then added to the flask per gram of graphene sheets. Ethanol is added to the flask and the mixture is ultrasonicated for about fifteen minutes. The ethanol is then evaporated and a known quantity of water is added to the flask to re-dissolve the free MB. The undissolved material is allowed to settle, preferably by centrifuging the sample. The concentration of MB in solution is determined using a UV-vis spectrophotometer by measuring the absorption at λₘₐₓ=298 nm relative to that of standard concentrations. The difference between the amount of MB that was initially added and the amount present in solution as determined by UV-vis spectrophotometry is assumed to be the amount of MB that has been adsorbed onto the surface of the graphene sheets. The surface area of the graphene sheets are then calculated using a value of 2.54 m² of surface covered per one mg of MB adsorbed.

The graphene sheets may have a bulk density of from about 0.01 to at least about 200 kg/m³. The bulk density includes all values and subvalues there between, especially including 0.05, 0.1, 0.5, 1, 5, 10, 15, 20, 25, 30, 35, 50, 75, 100, 125, 150, and 175 kg/m³.

The graphene sheets may be functionalized with, for example, oxygen-containing functional groups (including, for example, hydroxyl, carboxyl, and epoxy groups) and typically have an overall carbon to oxygen molar ratio (C/O ratio), as determined by bulk elemental analysis, of at least about 1:1, or more preferably, at least about 3:2. Examples of carbon to oxygen ratios include about 3:2 to about 85:15; about 3:2 to about 20:1; about 3:2 to about 30:1; about 3:2 to about 40:1; about 3:2 to about 60:1; about 3:2 to about 80:1; about 3:2 to about 100:1; about 3:2 to about 200:1; about 3:2 to about 500:1; about 3:2 to about 1000:1; about 3:2 to greater than 1000:1; about 10:1 to about 30:1; about 80:1 to about 100:1; about 20:1 to about 100:1; about 20:1 to about 500:1; about 20:1 to about 1000:1; about 50:1 to about 300:1; about 50:1 to about 500:1; and about 50:1 to about 1000:1. In some embodiments, the carbon to oxygen ratio is at least about 10:1, or at least about 15:1, or at least about 20:1, or at least about 35:1, or at least about 50:1, or at least about 75:1, or at least about 100:1, or at least about 200:1, or at least about 300:1, or at least about 400:1, or at least 500:1, or at least about 750:1, or at least about 1000:1; or at least about 1500:1, or at least about 2000:1. The carbon to oxygen ratio also includes all values and subvalues between these ranges.

The graphene sheets may contain atomic scale kinks. These kinks may be caused by the presence of lattice defects in, or by chemical functionalization of the two-dimensional hexagonal lattice structure of the graphite basal plane. The compositions may further comprise graphite (including natural, Kish, and synthetic, annealed, pyrolytic, highly oriented pyrolytic, etc. graphites). The ratio by weight of graphite to graphene sheets may be from about 2:98 to about 98:2, or from about 5:95 to about 95:5, or from about 10:90 to about 90:10, or from about 20:80 to about 80:20, or from about 30:70 to 70:30, or from about 40:60 to about 90:10, or from about 50:50 to about 85:15, or from about 60:40 to about 85:15, or from about 70:30 to about 85:15.

The graphene sheets may comprise two or more graphene powders having different particle size distributions and/or morphologies. The graphite may also comprise two or more graphite powders having different particle size distributions and/or morphologies.

By the terms “ink” and “coatings” are meant composition that are in a form that is suitable for application to a substrate as well as the material after it is applied to the substrate, while it is being applied to the substrate, and both before and after any post-application treatments (such as evaporation, cross-linking, curing, etc.). The components of the ink and coating compositions may vary during these stages. The inks and coatings may optionally further comprise a polymeric binder and other components.

The graphene sheets can be combined with polymers and/or other compounds using any suitable method, including melt processing (using, for example, a single or twin-screw extruder, a blender, a kneader, a Banbury mixer, etc.) and solution/dispersion blending. The polymers can be used as binders. When used, the polymers can be thermosets, thermoplastics, non-melt processible polymers, etc. Polymers can also comprise monomers that can be polymerized before, during, or after the application of the coating to the substrate. Polymeric binders can be cross-linked or otherwise cured after the coating has been applied to the substrate. Examples of polymers include, but are not limited to polyolefins (such as polyethylene, linear low density polyethylene (LLDPE), low density polyethylene (LDPE), high density polyethylene, polypropylene, and olefin copolymers), styrene/butadiene rubbers (SBR), styrene/ethylene/butadiene/styrene copolymers (SEBS), butyl rubbers, ethylene/propylene copolymers (EPR), ethylene/propylene/diene monomer copolymers (EPDM), polystyrene (including high impact polystyrene), poly(vinyl acetates), ethylene/vinyl acetate copolymers (EVA), poly(vinyl alcohols), ethylene/vinyl alcohol copolymers (EVOH), poly(vinyl butyral) (PVB), poly(vinyl formal), poly(methyl methacrylate) and other acrylate polymers and copolymers (such as methyl methacrylate polymers, methacrylate copolymers, polymers derived from one or more acrylates, methacrylates, ethyl acrylates, ethyl methacrylates, butyl acrylates, butyl methacrylates, glycidyl acrylates and methacrylates and the like), olefin and styrene copolymers, acrylonitrile/butadiene/styrene (ABS), styrene/acrylonitrile polymers (SAN), styrene/maleic anhydride copolymers, isobutylene/maleic anhydride copolymers, ethylene/acrylic acid copolymers, poly(acrylonitrile), poly(vinyl acetate) and poly(vinyl acetate) copolymers, poly(vinyl pyrrolidone) and poly(vinyl pyrrolidone) copolymers, vinyl acetate and vinyl pyrrolidone copolymers, polycarbonates (PC), polyamides, polyesters, liquid crystalline polymers (LCPs), poly(lactic acid) (PLA), poly(phenylene oxide) (PPO), PPO-polyamide alloys, polysulphone (PSU), polysulfides, polyetherketone (PEK), polyetheretherketone (PEEK), polyimides, polyoxymethylene (POM) homo- and copolymers, polyetherimides, fluorinated ethylene propylene polymers (FEP), poly(vinyl fluoride), poly(vinylidene fluoride), poly(vinylidene chloride), poly(vinyl chloride) (PVC), polyurethanes (thermoplastic and thermosetting (including cross-linked polyurethanes such as those cross-linked amines, etc.), aramides (such as Kevlar® and Nomex®), polysulfides, polytetrafluoroethylene (PTFE), polysiloxanes (including polydimethylenesiloxane, dimethylsiloxane/vinylmethylsiloxane copolymers, vinyldimethylsiloxane terminated poly(dimethylsiloxane), etc.), elastomers, epoxy polymers (including cross-linked epoxy polymers such as those cross-linked with polysulfones, amines, etc.), polyureas, alkyds, cellulosic polymers (such as nitrocellulose, ethyl cellulose, ethyl hydroxyethyl cellulose, carboxymethyl cellulose, cellulose acetate, cellulose acetate propionates, and cellulose acetate butyrates), polyethers (such as poly(ethylene oxide), poly(propylene oxide), poly(propylene glycol), oxide/propylene oxide copolymers, etc.), acrylic latex polymers, polyester acrylate oligomers and polymers, polyester diol diacrylate polymers, UV-curable resins, etc.

Examples of elastomers include, but are not limited to, polyurethanes, copolyetheresters, rubbers (including butyl rubbers and natural rubbers), styrene/butadiene copolymers, styrene/ethylene/butadiene/styrene copolymer (SEBS), polyisoprene, ethylene/propylene copolymers (EPR), ethylene/propylene/diene monomer copolymers (EPDM), polysiloxanes, and polyethers (such as poly(ethylene oxide), poly(propylene oxide), and their copolymers).

Examples of polyamides include, but are not limited to, aliphatic polyamides (such as polyamide 4,6; polyamide 6,6; polyamide 6; polyamide 11; polyamide 12; polyamide 6,9; polyamide 6,10; polyamide 6,12; polyamide 10,10; polyamide 10,12; and polyamide 12,12), alicyclic polyamides, and aromatic polyamides (such as poly(m-xylylene adipamide) (polyamide MXD,6)) and polyterephthalamides such as poly(dodecamethylene terephthalamide) (polyamide 12,T), poly(decamethylene terephthalamide) (polyamide 10,T), poly(nonamethylene terephthalamide) (polyamide 9,T), the polyamide of hexamethylene terephthalamide and hexamethylene adipamide, the polyamide of hexamethyleneterephthalamide, and 2-methylpentamethyleneterephthalamide), etc. The polyamides may be polymers and copolymers (i.e., polyamides having at least two different repeat units) having melting points between about 120 and 255° C. including aliphatic copolyamides having a melting point of about 230° C. or less, aliphatic copolyamides having a melting point of about 210° C. or less, aliphatic copolyamides having a melting point of about 200° C. or less, aliphatic copolyamides having a melting point of about 180° C. or less, etc. Examples of these include those sold under the trade names Macromelt by Henkel and Versamid by Cognis.

Examples of acrylate polymers include those made by the polymerization of one or more acrylic acids (including acrylic acid, methacrylic acid, etc.) and their derivatives, such as esters. Examples include methyl acrylate polymers, methyl methacrylate polymers, and methacrylate copolymers. Examples include polymers derived from one or more acrylates, methacrylates, acrylic acid, methacrylic acid, methyl acrylate, methyl methacrylate, ethyl acrylate, ethyl methacrylate, butyl acrylate, butyl methacrylate, glycidyl acrylate, glycidyl methacrylates, 2-ethylhexyl acrylate, 2-ethylhexyl methacrylate, hydroxyethyl acrylate, hydroxyethyl (meth)acrylate, acrylonitrile, and the like. The polymers may comprise repeat units derived from other monomers such as olefins (e.g. ethylene, propylene, etc.), vinyl acetates, vinyl alcohols, vinyl pyrrolidones, etc. They may include partially neutralized acrylate polymers and copolymers (such as ionomer resins).

Examples of polymers include Elvacite® polymers supplied by Lucite International, Inc., including Elvacite® 2009, 2010, 2013, 2014, 2016, 2028, 2042, 2045, 2046, 2550, 2552, 2614, 2669, 2697, 2776, 2823, 2895, 2927, 3001, 3003, 3004, 4018, 4021, 4026, 4028, 4044, 4059, 4400, 4075, 4060, 4102, etc. Other polymer families include Bynel® polymers (such as Bynel® 2022 supplied by DuPont) and Joncryl® polymers (such as Joncryl® 678 and 682). Examples of polyesters include, but are not limited to, poly(butylene terephthalate) (PBT), poly(ethylene terephthalate) (PET), poly(1,3-propylene terephthalate) (PPT), poly(ethylene naphthalate) (PEN), poly(cyclohexanedimethanol terephthalate) (PCT), etc.

In some embodiment, the polymer has an acid number of at least about 5, or at least about 10, or at least about 15, or at least about 20. In other embodiments, the glass transition temperature of at least one polymer is no greater than about 100° C., 90° C., or no greater than about 80° C., or no greater than about 70° C., or no greater than about 60° C., or no greater than about 50° C., or no greater than about 40° C.

In some cases, when a binder is used, it can be present relative to graphene sheets and graphite, when used, in from about 1 to about 99 weight percent, or from about 1 to about 50 weight percent, or from about 1 to about 30 weight percent, or from about 1 to about 20 weight percent, or from about 5 to about 80 weight percent, or from about 5 to about 60 weight percent, or from about 5 to about 30 weight percent, or from about 15 to about 85 weight percent, or from about 15 to about 60 weight percent, or from about 15 to about 30 weight percent, or from about 25 to about 80 weight percent, or from about 25 to about 50 weight percent, or from about 40 to about 90 weight percent, or from about 50 to about 90 weight percent, or from about 70 to about 95 weight percent, based on the total weight of binder and graphene plus graphite when present.

Examples of solvents into which the graphene sheets and aromatic compounds can be dispersed include water, distilled or synthetic isoparaffinic hydrocarbons (such Isopar® and Norpar® (both manufactured by Exxon) and Dowanol® (manufactured by Dow), citrus terpenes and mixtures containing citrus terpenes (such as Purogen, Electron, and Positron (all manufactured by Ecolink)), terpenes and terpene alcohols (including terpineols, including alpha-terpineol), limonene, aliphatic petroleum distillates, alcohols (such as methanol, ethanol, n-propanol, i-propanol, n-butanol, i-butanol, sec-butanol, tert-butanol, pentanols, i-amyl alcohol, hexanols, heptanols, octanols, diacetone alcohol, butyl glycol, etc.), ketones (such as acetone, methyl ethyl ketone, cyclohexanone, i-butyl ketone, 2,6,8,trimethyl-4-nonanone etc.), esters (such as methyl acetate, ethyl acetate, n-propyl acetate, i-propyl acetate, n-butyl acetate, i-butyl acetate, tert-butyl acetate, carbitol acetate, etc.), glycol ethers, ester and alcohols (such as 2-(2-ethoxyethoxy)ethanol, propylene glycol monomethyl ether and other propylene glycol ethers; ethylene glycol monobutyl ether, 2-methoxyethyl ether (diglyme), propylene glycol methyl ether (PGME); and other ethylene glycol ethers; ethylene and propylene glycol ether acetates, diethylene glycol monoethyl ether acetate, 1-methoxy-2-propanol acetate (PGMEA); and hexylene glycol (such as Hexasol™ (supplied by SpecialChem)), dibasic esters (such as dimethyl succinate, dimethyl glutarate, dimethyl adipate), dimethylsulfoxide (DMSO), dimethyl-3,4,5,6-tetrahydro-2(1H)-pyrimidinone (DMPU), imides, amides (such as dimethylformamide (DMF), dimethylacetamide, etc.), cyclic amides (such as N-methylpyrrolidone and 2-pyrrolidone), lactones (such as beta-propiolactone, gamma-valerolactone, delta-valerolactone, gamma-butyrolactone, epsilon-caprolactone), cyclic imides (such as imidazolidinones such as N,N′-dimethylimidazolidinone (1,3-dimethyl-2-imidazolidinone)), aromatic solvents and aromatic solvent mixtures (such as toluene, xylenes, mesitylene, cumene, etc.), petroleum distillates, naphthas (such as VM&P naphtha), and mixtures of two or more of the foregoing and mixtures of one or more of the foregoing with other carriers. Solvents can be low- or non-VOC solvents, non-hazardous air pollution solvents, and non-halogenated solvents.

The compositions can contain additives and other components such as dispersion aids (including surfactants, emulsifiers, and wetting aids), adhesion promoters, thickening agents (including clays), defoamers and antifoamers, biocides, additional fillers, flow enhancers, stabilizers, crosslinking and curing agents, conductive additives, etc. Examples of dispersing aids include glycol ethers (such as poly(ethylene oxide), block copolymers derived from ethylene oxide and propylene oxide (such as those sold under the trade name Pluronic® by BASF), acetylenic diols (such as 2,5,8,11-tetramethyl-6-dodecyn-5,8-diol ethoxylate and others sold by Air Products under the trade names Surfynol® and Dynol®), salts of carboxylic acids (including alkali metal and ammonium salts), and polysiloxanes.

Examples of grinding aids include stearates (such as Al, Ca, Mg, and Zn stearates) and acetylenic diols (such as those sold by Air Products under the trade names Surfynol® and Dynol®).

Examples of adhesion promoters include titanium chelates and other titanium compounds such as titanium phosphate complexes (including butyl titanium phosphate), titanate esters, diisopropoxy titanium bis(ethyl-3-oxobutanoate, isopropoxy titanium acetylacetonate, and others sold by Johnson-Matthey Catalysts under the trade name Vertec.

The compositions may optionally comprise at least one “multi-chain lipid”, by which term is meant a naturally-occurring or synthetic lipid having a polar head group and at least two nonpolar tail groups connected thereto. Examples of polar head groups include oxygen-, sulfur-, and halogen-containing, phosphates, amides, ammonium groups, amino acids (including □-amino acids), saccharides, polysaccharides, esters (Including glyceryl esters), zwitterionic groups, etc.

The tail groups may be the same or different. Examples of tail groups include alkanes, alkenes, alkynes, aromatic compounds, etc. They may be hydrocarbons, functionalized hydrocarbons, etc. The tail groups may be saturated or unsaturated. They may be linear or branched. The tail groups may be derived from fatty acids, such as oleic acid, palmitic acid, stearic acid, arachidic acid, erucic acid, arachadonic acid, linoleic acid, linolenic acid, oleic acid, etc.

Examples of multi-chain lipids include, but are not limited to, lecithin and other phospholipids (such as phosphatidylcholine, phosphoglycerides (including phosphatidylserine, phosphatidylinositol, phosphatidylethanolamine (cephalin), and phosphatidylglycerol) and sphingomyelin); glycolipids (such as glucosyl-cerebroside); saccharolipids; sphingolipids (such as ceramides, di- and triglycerides, phosphosphingolipids, and glycosphingolipids); etc. They may be amphoteric, including zwitterionic.

Examples of thickening agents include glycol ethers (such as poly(ethylene oxide), block copolymers derived from ethylene oxide and propylene oxide (such as those sold under the trade name Pluronic® by BASF), long-chain carboxylate salts (such aluminum, calcium, zinc, etc. salts of stearates, oleats, palmitates, etc.), aluminosilicates (such as those sold under the Minex® name by Unimin Specialty Minerals and Aerosil® 9200 by Evonik Degussa), fumed silica, natural and synthetic zeolites, etc.

Compositions may contain electrically and/or thermally conductive components, such as metals (including metal alloys), conductive metal oxides, conductive carbons, polymers, metal-coated materials, etc. These components can take a variety of forms, including particles, powders, flakes, foils, needles, etc.

Examples of metals include, but are not limited to silver, copper, aluminum, platinum, palladium, nickel, chromium, gold, zinc, tin, iron, gold, lead, steel, stainless steel, rhodium, titanium, tungsten, magnesium, brass, bronze, colloidal metals, etc. Examples of metal oxides include antimony tin oxide and indium tin oxide and materials such as fillers coated with metal oxides. Metal and metal-oxide coated materials include, but are not limited to metal coated carbon and graphite fibers, metal coated glass fibers, metal coated glass beads, metal coated ceramic materials (such as beads), etc. These materials can be coated with a variety of metals, including nickel. The metals and/or metal oxides can absorb and/or decompose predetermined atoms, molecules, and/or ions upon binding, which can be utilized to detect the presence thereof.

Examples of electrically conductive polymers include, but are not limited to, polyacetylene, polyethylene dioxythiophene (PEDOT), poly(styrenesulfonate) (PSS), PEDOT:PSS copolymers, polythiophene and polythiophenes, poly(3-alkylthiophenes), poly(2,5-bis(3-tetradecylthiophen-2-yl)thieno[3,2-b]thiophene) (PBTTT), poly(phenylenevinylene), polypyrene, polycarbazole, polyazulene, polyazepine, polyflurorenes, polynaphthalene, polyisonaphthalene, polyaniline, polypyrrole, poly(phenylene sulfide), polycarbozoles, polyindoles, polyphenylenes, copolymers of one or more of the foregoing, etc., and their derivatives and copolymers. The conductive polymers may be doped or undoped. They may be doped with boron, phosphorous, iodine, etc.

Examples of conductive carbons include, but are not limited to, graphite (including natural, Kish, and synthetic, annealed, pyrolytic, highly oriented pyrolytic, etc. graphites), graphitized carbon, mesoporous carbon, carbon black, carbon fibers and fibrils, carbon whiskers, vapor-grown carbon nanofibers, metal coated carbon fibers, carbon nanotubes (including single- and multi-walled nanotubes), fullerenes, activated carbon, carbon fibers, expanded graphite, expandable graphite, graphite oxide, hollow carbon spheres, carbon foams, etc.

Inks and coatings can be formed by blending the graphene sheets and aromatic compounds with at least one solvent and/or binder, and, optionally, other additives. Blending can be done using one or more of the preceding methods. The compositions may be made using any suitable method, including wet or dry methods and batch, semi-continuous, and continuous methods. Dispersions, suspensions, solutions, etc. of graphene sheets and one or more aromatic compounds (including inks and coatings formulations) can be made or processed (e.g., milled/ground, blended, dispersed, suspended, etc.) by using suitable mixing, dispersing, and/or compounding techniques

The inks and coatings can comprise aromatic compounds having at least one aromatic ring. They may comprise two or more aromatic rings. When two or more aromatic rings are present, they may be fused, bonded directly to each other, bonded using a spacer of one or more atoms, etc. The aromatic rings can be all-carbon based or can contain heteroatoms (heteroaromatics). Examples of rings systems the aromatic compounds can be based on (derivatives of) include benzene, naphthalene, anthracene, tetracene, pentacene, phenanthrene, pyrene, pyrene, benzo[a]pyrene, coronene, chryrsene, triphenylene, perylene, corannulene, ovalene, acenaphthylene, fluorine, biphenyl, bisphenols, etc. Examples of heteroaromatic ring systems the aromatic compounds can be based on include furan, thiophene, pyrrole, pyridine, indole, imidazole, pyrimidine, purine, etc. They preferably have a molecular weight of less than about 2000 or more preferably of less than about 1000 of yet more preferably of less than about 500.

The aromatic ring systems may be functionalized or multifunctional compounds that are substituted with one, two, or more functional groups. The functional groups are preferably nucleophilic or electrophilic. In some cases, they are capable of reacting with hydroxyl groups, carboxylic acids or carboxylic acid derivates, and/or epoxy groups. Examples of functional groups include, but are not limited to, hydroxyls, hydroperoxy and peroxy groups, carboxylic acids, carboxylic acid salts (e.g. Li, Na, K, Mg, Ca, Zn, etc. salts), esters, anhydrides, acid halides (including acid chlorides), aldehydes (e.g. formyl groups), acetals, orthoesters, carbonates, amino groups, amides, imines, imides, azides, cyanates, isocyanates, thiol groups, sulfo, sulfino, thiocyanates, expoxies, ethers, etc. In some cases, there are one, two, three, four, or more functional groups in the functionalized aromatic compound.

Examples include compounds of the general formulas:

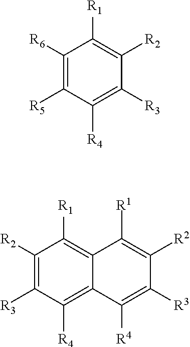

wherein in each case one or more of the substituents present (R¹ to R⁵ and R₁ to R₆) can be a functional group or be substituted with a functional group. Other substituents can be H, hydrocarbon groups (including alkyl, alkenyl, alkynyl, aryl, alicyclic, etc. groups), halides (e.g. chlorides, bromides, iodides, fluorides), etc. The functional groups can be directly bonded to the aromatic ring. In some embodiments, when there are two or more aromatic rings, there can be at least one functional group is present on two different rings.

Examples of aromatic compounds include benozoic acid and benzoic acid derivatives, hydroxybenzoic acids (including 4-hydroxybenzoic acid), hydroxybenzaldehydes (including 4-hydroxybenzaldehyde), formylbenzoic acids (including 4-formylbenzoic acid), terephthaldehyde, isophthaldehyde, phthaldialdehyde, terephthalic acid (and esters such as methyl terephthalate, dimethyl terephthalate, etc.), isophthalic acid (and esters such as methyl isophthalate, dimethyl isophthalate, etc.), phthalic acid (and esters such as methyl phthalate, dimethyl phthalate, etc.), phthalic anhydride, bisphenols (such as bisphenol A), biphenyl, 4,4′-biphenol, 3,3′-biphenol, 2,2′-biphenol, 4-hydroxybiphenyl, 3-hydroxybiphenyl, 2-hydroxybiphenyl, naphthalene, hydroxynaphthalenes, dihydroxynaphthalenes (including 2,6-dihydroxynaphthalene, 1,5-dihydroxynaphthalene, 2,3-dihydroxynaphthalene, 1,7-dihydroxynaphthalene, 1,4-dihydroxynaphthalene, 1,2-dihydroxynaphthalene, 1,3-dihydroxynaphthalene, 2,7-dihydroxynaphthalene, and 1,6-dihydroxynaphthalene), naphthalenecarboxylic acids, naphthalenecarboxylic acid esters, naphthalenedicarboxylic acids, naphthalenedicarboxylic acid esters, anthracene, pyrene, pentacene phenol, hydroquinone, catechol, resorcinol, etc.

In some cases, the aromatic compounds can be present relative to graphene sheets in weight ratio of from about 0.1:99.9 to about 75:25, or of from about 0.5:99.5 to about 75:25, or of from about 0.5:99.5 to about 50:50, or of from about 0.5:99.5 to about 25:75, or of from about 0.5:99.5 to about 15:85, or of from about 0.5:99.5 to about 10:90, or of from about 0.5:99.5 to about 5:95, or of from about 1:99 to about 75:25, or of from about 1:99 to about 50:50, or of from about 1:99 to about 25:75, or of from about 1:99 to about 15:85, or of from about 1:99 to about 10:90, or of from about 1:99 to about 5:95, or of from about 2:98 to about 75:25, or of from about 2:98 to about 50:50, or of from about 2:98 to about 25:75, or of from about 2:98 to about 15:85, or of from about 2:98 to about 10:90, or of from about 2:98 to about 5:95, of from about 5:95 to about 50:50, of from about 5:95 to about 25:75, of from about 10:90 to about 75:25, of from about 10:90 to about 50:50, of from about 10:90 to about 25:75.

In some cases, the aromatic compounds may react with the graphene sheets and/or any polymeric binder that is present. In these cases, the aromatic compound can serve to crosslink the graphene sheets to itself and/or to the binder and/or crosslink the polymeric binder to itself. The formulations can have improved electrical conductivity and mechanical properties (such as improved adhesion when formed into inks or coatings and printed).

The compositions may further comprise one or more acid catalysts. The acids can be organic acids or mineral acids. The pKₐ in water of the acid is preferably less than about 4, or more preferably less than about 3, or yet more preferably less than about 2.5. The pKₐ in water may be less than about 2, or less than about 1, or less than about 0. The acids may be in a blocked form. In such cases, the pKₐ is based on the unblocked acid. The acid may be a curing catalyst. Examples of mineral acids include sulfuric acid, hydrochloric acid, nitric acid, nitrous acid, phosphoric acid, boric acid, hydrobromic acid, perchloric acid, etc.

Examples of acids include sulfur-based acids such as sulfonic acids, polysulfonic acids (such as disulfonic acids), sulfinic acids, including monomeric and polymeric organic sulfonic acids such as aromatic sulfonic acids such as benzenesulfonic acids, alkylbenzene sulfonic acids, alkyl and aliphatic sulfonic acids, toluenesulfonic acids, and naphthalenesulfonic acids. Examples of sulfonic acids include p-toluenesulfonic acid, benzenesulfonic acid, cresol sulfonic acid, 4-ethylbenzenesulfonic acid, xylenesulfonic acid, dimethylbenzenesulfonic acid, pehnolsulfonic acid, dinonylnaphthalenesulfonic acid (DNNSA), dinonylnaphthalenedisulfonic acid (DNNDSA), dodecylbenzenesulfonic acid (DDBSA), methanesulfonic acid, etc. Examples also include sulfonic acid resins such as poly(stryenesulfonic acid), sulfonated fluoropolymers (such as sulfonated tetrafluoroethylene (e.g., Nafion®)), etc.

The acids may be phosphorous-based acids, such as phosphoric acid and its derivatives, phosphorous acid and its derivatives, organic phosphorous and phosphate-based acids, such as alkyl and dialkyl acid phosphates, etc. Examples include amyl acid phosphate, diamyl acid phosphate, butyl acid phosphate, dibutyl acid phosphate, ethyl acid phosphate, diethyl acid phosphate, octyl acid phosphate, dioctyl acid phosphate, etc. They may be metal salts of phosphorous-based acids, such as metal salts of phosphoric acid and phosphoric acid esters.

In some embodiments, the acids can be present in the compositions in about 5 to about 95 weight percent, or about 10 to about 90 weight percent, or about 10 to about 70 weight percent, or about 20 to about 70 weight percent, or about 30 to about 70 weight percent, or about 40 to about 60 weight percent, based on the total weight of acid and aromatic compound.

The graphene sheets are graphite sheets preferably having a surface area of from about 100 to about 2630 m²/g. In some embodiments, the graphene sheets primarily, almost completely, or completely comprise fully exfoliated single sheets of graphite (these are approximately ≤1 nm thick and are often referred to as “graphene”), while in other embodiments, at least a portion of the graphene sheets may comprise partially exfoliated graphite sheets, in which two or more sheets of graphite have not been exfoliated from each other. The graphene sheets may comprise mixtures of fully and partially exfoliated graphite sheets. Graphene sheets are distinct from carbon nanotubes. Graphene sheets may have a “platey” (e.g. two-dimensional) structure and do not have the needle-like form of carbon nanotubes. The two longest dimensions of the graphene sheets may each be at least about 10 times greater, or at least about 50 times greater, or at least about 100 times greater, or at least about 1000 times greater, or at least about 5000 times greater, or at least about 10,000 times greater than the shortest dimension (i.e. thickness) of the sheets.

They graphene sheets and aromatic compound can be combined with polymers to make composites (including polymer composites), etc. They can be dispersed in one or more solvents with or without a polymer binder. They can be used in thermal transfer applications. They can be used in electrodes, such as those used in solar cells (including dye-sensitized solar cells, organic solar cells, etc.), light-emitting diodes, batteries (such as electrodes for use in rechargeable, lithium ion, lithium polymer, lithium air, etc. batteries), capacitors (including ultracapacitors), etc. Polymer composites can be used in gas barrier applications. Rubber composites can be used in tire applications. The compositions can be in the form of adhesives.

The inks and coatings can be used to make printed electronic devices of the present invention (also referred to as “printed electronics) that may be in the form of complete devices, antennas, and/or sensors, parts or sub elements of devices, antennas, and/or sensors, and/or electronic components thereof.

Printed electronics may be prepared by applying the inks and coatings to the substrate in a pattern comprising an electrically conductive pathway designed to achieve the desired electronic device. The pathway may be solid, mostly solid, in a liquid or gel form.

The printed electronic devices may take on a wide variety of forms and be used to detect and/or sense the presence of chemicals, temperature levels, gases, and/or fluids. The printed electronic may contain multiple layers of electronic components (e.g. circuits) and/or substrates. All or part of the printed layer(s) may be covered or coated with another material such as a cover coat, varnish, cover layer, cover films, dielectric coatings, electrolytes and other electrically conductive materials, etc. There may also be one or more materials between the substrate and printed circuits. Layers may include semiconductors, metal foils, dielectric materials, etc.

The printed electronics may further comprise additional components, such as processors, memory chips, other microchips, batteries, resistors, diodes, capacitors, transistors.

The compositions, including those in the form of polymer composites, dispersions, inks and coatings, etc. can be electrically and/or thermally conductive. In some embodiments, the composition can have a conductivity of at least about 10⁻⁸ S/m. It can have a conductivity of about 10⁻⁶ S/m to about 10⁵ S/m, or of about 10⁻⁵ S/m to about 10⁵ S/m. In other embodiments of the invention, the coating has conductivities of at least about 0.001 S/m, of at least about 0.01 S/m, of at least about 0.1 S/m, of at least about 1 S/m, of at least about 10 S/m, of at least about 100 S/m, or at least about 1000 S/m, or at least about 10,000 S/m, or at least about 20,000 S/m, or at least about 30,000 S/m, or at least about 40,000 S/m, or at least about 50,000 S/m, or at least about 60,000 S/m, or at least about 75,000 S/m, or at least about 105 S/m, or at least about 106 S/m.

In some embodiments, the surface resistivity of the composition (including polymer composites, cured inks and coatings, etc.) may be no greater than about 10000 Ω/square/mil, or no greater than about 5000 Ω/square/mil, or no greater than about 1000 Ω/square/mil or no greater than about 700 Ω/square/mil, or no greater than about 500 Ω/square/mil, or no greater than about 350 Ω/square/mil, or no greater than about 200 Ω/square/mil, or no greater than about 200 Ω/square/mil, or no greater than about 150 Ω/square/mil, or no greater than about 100 Ω/square/mil, or no greater than about 75 Ω/square/mil, or no greater than about 50 Ω/square/mil, or no greater than about 30 Ω/square/mil, or no greater than about 20 Ω/square/mil, or no greater than about 10 Ω/square/mil, or no greater than about 5 Ω/square/mil, or no greater than about 1 Ω/square/mil, or no greater than about 0.1 Ω/square/mil, or no greater than about 0.01 Ω/square/mil, or no greater than about 0.001 Ω/square/mil.

In some embodiments, the composition can have a thermal conductivity of about 0.1 to about 50 W/m·K, or of about 0.5 to about 30 W/m·K, or of about 0.1 to about 0.5 W/m·K, or of about 0.1 to about 1 W/m·K, or of about 0.1 to about 5 W/m·K, or of about 0.5 to about 2 W/m·K, or of about 1 to about 5 W/m·K, or of about 0.1 to about 0.5 W/m·K, or of about 0.1 to about 50 W/m·K, or of about 1 to about 30 W/m·K, or of about 1 to about 20 W/m·K, or of about 1 to about 10 W/m·K, or of about 1 to about 5 W/m·K, or of about 2 to about 25 W/m·K, or of about 5 to about 25 W/m·K, or of at least about 0.7 W/m·K, or of at least 1 W/m·K, or of at least 1.5 W/m·K, or of at least 3 W/m·K, or of at least 5 W/m·K, or of at least 7 W/m·K, or of at least 10 W/m·K, or of at least 15 W/m·K. For example, components of the compositions, such as one or more of the graphene sheets, aromatic compounds, graphite (if used), binders, carriers, and/or other components can be processed (e.g., milled/ground, blended, etc. by using suitable mixing, dispersing, and/or compounding techniques and apparatus, including ultrasonic devices, high-shear mixers, ball mills, attrition equipment, sand mills, two-roll mills, three-roll mills, cryogenic grinding crushers, extruders, kneaders, double planetary mixers, triple planetary mixers, high pressure homogenizers, horizontal and vertical wet grinding mills, etc.) Processing (including grinding) technologies can be wet or dry and can be continuous or discontinuous. Suitable materials for use as grinding media include metals, carbon steel, stainless steel, ceramics, stabilized ceramic media (such as cerium yttrium stabilized zirconium oxide), PTFE, glass, tungsten carbide, etc. Methods such as these can be used to change the particle size and/or morphology of the graphite, graphene sheets, other components, and blends or two or more components.

Components may be processed together or separately and may go through multiple processing (including mixing/blending) stages, each involving one or more components (including blends).

There is no particular limitation to the way in which the graphene sheets, graphite (if used), the aromatic compounds, and other components are processed and combined. For example, graphene sheets and/or graphite may be processed into given particle size distributions and/or morphologies separately and then combined for further processing with or without the presence of additional components. Unprocessed graphene sheets and/or graphite may be combined with processed graphene sheets and/or graphite and further processed with or without the presence of additional components. Processed and/or unprocessed graphene sheets and/or processed and/or unprocessed graphite may be combined with other components, such as one or more binders and then combined with processed and/or unprocessed graphene sheets and/or processed and/or unprocessed graphite. Two or more combinations of processed and/or unprocessed graphene sheets and/or processed and/or unprocessed graphite that have been combined with other components may be further combined or processed. Any of the foregoing processing steps can be done in the presence of at least one aromatic compound.

In one embodiment, if a multi-chain lipid is used, it can be added to graphene sheets (and/or graphite if present) before processing.

After blending and/or grinding steps, additional components may be added to the compositions, including, but not limited to, thickeners, viscosity modifiers, binders, etc. The compositions may also be diluted by the addition of more carrier.

The inks and coatings can be applied to a wide variety of substrates to form the sensor and other electronic components, including, but not limited to, flexible and/or stretchable materials, silicones and other elastomers and other polymeric materials, metals (such as aluminum, copper, steel, stainless steel, etc.), adhesives, heat-sealable materials (such as cellulose, biaxially oriented polypropylene (BOPP), poly(lactic acid), polyurethanes, etc.), fabrics (including cloths) and textiles (such as cotton, wool, polyesters, rayon, etc.), clothing, glasses and other minerals, ceramics, silicon surfaces, wood, paper, cardboard, paperboard, cellulose-based materials, glassine, labels, silicon and other semiconductors, laminates, corrugated materials, concrete, bricks, and other building materials, etc. Substrates can be in the form of films, papers, wafers, silicon wafers, larger three-dimensional objects, etc.

The substrates may have been treated with other coatings (such as paints) or similar materials before the inks and coatings are applied. Examples include substrates (such as PET) coated with indium tin oxide, antimony tin oxide, etc. They may be woven, nonwoven, in mesh form; etc. They may be woven, nonwoven, in mesh form; etc.

The substrates may be paper-based materials generally (including paper, paperboard, cardboard, glassine, etc.). Paper-based materials can be surface treated. Examples of surface treatments include coatings such as polymeric coatings, which can include PET, polyethylene, polypropylene, acetates, nitrocellulose, etc. Coatings may be adhesives. Paper based materials may be sized.

Examples of polymeric materials include, but are not limited to, those comprising thermoplastics and thermosets, including elastomers and rubbers (including thermoplastics and thermosets), silicones, fluorinated polysiloxanes, natural rubber, butyl rubber, chlorosulfonated polyethylene, chlorinated polyethylene, styrene/butadiene copolymers (SBR), styrene/ethylene/butadiene/stryene copolymers (SEBS), styrene/ethylene/butadiene/stryene copolymers grafted with maleic anhydride, styrene/isoprene/styrene copolymers (SIS), polyisoprene, nitrile rubbers, hydrogenated nitrile rubbers, neoprene, ethylene/propylene copolymers (EPR), ethylene/propylene/diene copolymers (EPDM), ethylene/vinyl acetate copolymer (EVA), hexafluoropropylene/vinylidene fluoride/tetrafluoroethylene copolymers, tetrafluoroethylene/propylene copolymers, fluorelastomers, polyesters (such as poly(ethylene terephthalate), poly(butylene terephthalate), poly(ethylene naphthalate), liquid crystalline polyesters, poly(lactic acid), etc.); polystyrene; polyamides (including polyterephthalamides); polyimides (such as Kapton®); aramids (such as Kevlar® and Nomex®); fluoropolymers (such as fluorinated ethylene propylene (FEP), polytetrafluoroethylene (PTFE), poly(vinyl fluoride), poly(vinylidene fluoride), etc.); polyetherimides; poly(vinyl chloride); poly(vinylidene chloride); polyurethanes (such as thermoplastic polyurethanes (TPU); spandex, cellulosic polymers (such as nitrocellulose, cellulose acetate, etc.); styrene/acrylonitriles polymers (SAN); arcrylonitrile/butadiene/styrene polymers (ABS); polycarbonates; polyacrylates; poly(methyl methacrylate); ethylene/vinyl acetate copolymers; thermoset epoxies and polyurethanes; polyolefins (such as polyethylene (including low density polyethylene, high density polyethylene, ultrahigh molecular weight polyethylene, etc.), polypropylene (such as biaxially-oriented polypropylene, etc.); Mylar; etc. They may be non-woven materials, such as DuPont Tyvek®. They may be adhesive or adhesive-backed materials (such as adhesive-backed papers or paper substitutes). They may be mineral-based paper substitutes such as Teslin® from PPG Industries. The substrate may be a transparent or translucent or optical material, such as glass, quartz, polymer (such as polycarbonate or poly(meth)acrylates (such as poly(methyl methacrylate).

The inks and coatings may be applied to the substrate using any suitable method, including, but not limited to, painting, pouring, spin casting, solution casting, dip coating, powder coating, by syringe or pipette, spray coating, curtain coating, lamination, co-extrusion, electrospray deposition, ink-jet printing, spin coating, thermal transfer (including laser transfer) methods, doctor blade printing, screen printing, rotary screen printing, gravure printing, lithographic printing, intaglio printing, digital printing, capillary printing, offset printing, electrohydrodynamic (EHD) printing (a method of which is described in WO 2007/053621, which is hereby incorporated herein by reference), microprinting, pad printing, tampon printing, stencil printing, wire rod coating, drawing, flexographic printing, stamping, xerography, microcontact printing, dip pen nanolithography, laser printing, via pen or similar means, etc. The compositions can be applied in multiple layers.

After they have been applied to a substrate, the inks and coatings may be cured using any suitable technique, including drying and oven-drying (in air or another inert or reactive atmosphere), UV curing, IR curing, drying, crosslinking, thermal curing, laser curing, IR curing, microwave curing or drying, sintering, and the like.

The cured inks and coatings can have a variety of thicknesses. For example, they can optionally have a thickness of at least about 2 nm, or at least about 5 nm. In various embodiments, the coatings can optionally have a thickness of about 2 nm to 2 mm, about 5 nm to 1 mm, about 2 nm to about 100 nm, about 2 nm to about 200 nm, about 2 nm to about 500 nm, about 2 nm to about 1 micrometer, about 5 nm to about 200 nm, about 5 nm to about 500 nm, about 5 nm to about 1 micrometer, about 5 nm to about 50 micrometers, about 5 nm to about 200 micrometers, about 10 nm to about 200 nm, about 50 nm to about 500 nm, about 50 nm to about 1 micrometer, about 100 nm to about 10 micrometers, about 1 micrometer to about 2 mm, about 1 micrometer to about 1 mm, about 1 micrometer to about 500 micrometers, about 1 micrometer to about 200 micrometers, about 1 micrometer to about 100 micrometers, about 50 micrometers to about 1 mm, about 100 micrometers to about 2 mm, about 100 micrometers to about 1 mm, about 100 micrometers to about 750 micrometers, about 100 micrometers to about 500 micrometers, about 500 micrometers to about 2 mm, or about 500 micrometers to about 1 mm.

When applied to a substrate, the inks and coatings can have a variety of forms. They can be present as a film or lines, patterns, letters, numbers, circuitry, logos, identification tags, and other shapes and forms. The inks and coatings may be covered in whole or in part with additional material, such as over coatings, varnishes, polymers, fabrics, etc.

The inks and coatings can be applied to the same substrate in varying thicknesses at different points and can be used to build up three-dimensional structures on the substrate.

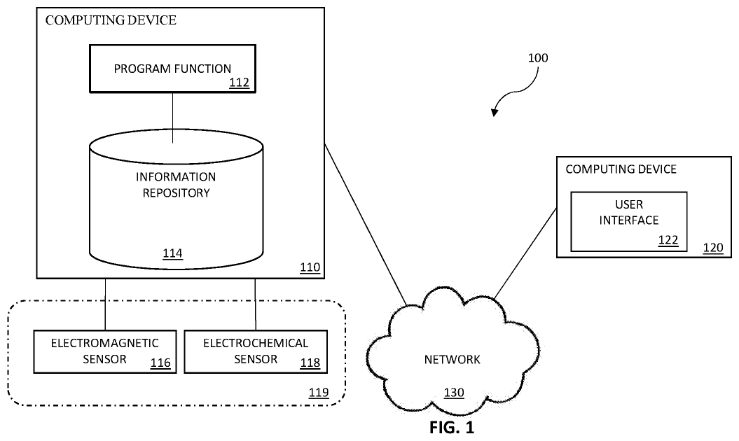

The present invention is described below with reference to the Figures. FIG. 1 is a block diagram depicting an environment, generally 100, in accordance with an embodiment of the present invention. Environment 100 can include computing devices 120 and 110, all in communication via network 130. Computing device 110 can be replaced by an electronic device, such as light-emitting diodes (LED) or electromagnetic devices that produce sound in response to triggering of the sensor. In certain embodiments, environment 100 does not include computing device 120 and/or network 130. Network 130 can be, for example, a local area network (LAN), a wide area network (WAN), such as the Internet, or a combination of the two, and can be wired, wireless, or fiber optic connections. Network 130 can be compatible with a variety of frequencies, such as those associated with Bluetooth, Wi-Fi, LTE, cellular, radio, microwave, as well as wireless communication. In general, network 130 can be any combination of connections and protocols that will support communications between computing devices 120 and 110.

Computing device 120 provides access to computing device 110, in accordance with an embodiment of the present invention. Computing device 120 can be included in a distributed control system, supervisory control and data acquisition system, and/or perform similar functions as such systems. Computing device 120 includes user interface 122, which allows users to access programs, information, and/or sensors that are associated with computing device 110. In an embodiment, user interface 122 may include hardware and/or software components. User interface 122 may be a graphics or text-based interface. Computing device 110 is in electrical communication with printed electronic device 119, which comprises electromagnetic sensor (“EMS”) 116, electrochemical sensor (ECS) 118, in accordance with an embodiment of the present invention.

Computing device 110 is a computing device that communicates with sensors, including, but not limited to, electromagnetic sensors, such as EMS 116, electrochemical sensors, such as ECS 118, electrophysical sensors, temperature sensors, catalytic combustion sensors, and/or strain sensors, in accordance with an embodiment of the present invention. Computing device 110 includes program function 112 and information repository 114. Program function 112 is in communication with information repository 114, which is an information store that includes data generated by EMS 116 and ECS 118 (discussed further below). In an embodiment, Program function 112 is software that facilitates the monitoring of vessels, in accordance with an embodiment of the present invention. Program function 112 can control the operation of sensors, such EMS 116 and ECS 118, using predetermined instructions or user input received from computing device 120. Program function 112 can store data that is generated by EMS 116 and/or ECS 118 in, for example, information repository 114.

EMS 116 and/or ECS 118 can be included in printed electronic device 119. In other embodiments, printed electronic device includes one or more copies of EMS 116 and/or ECS 118. Printed electronic device 119 may take on a variety of forms and may contain multiple layers of electronic components (e.g. circuits) and/or substrates. In addition to the substrates discussed above, printed electronic device 119 may be applied to the surface of a storage or conveyance vessel, fuel line, or oil drilling equipment. Drilling equipment refers to the components that are used for drilling for oil/gas/water; finding and locating oil/gas/water; as well as extracting oil/gas/water. Drilling equipment includes, but is not limited to, crown and crown block situated at the apex of the rig, traveling block, draw works, sand pipe, engine, fuel or water tanks, swivel, rotary hose, turn table, pipe rack, conductor pipe, bore hole, bit, drill pipe, mud pit and mud pump, mast or derrick, fuel lines, drill collar, and drill pipe. All or part of the printed layer(s) of printed device 119 may be covered or coated with another material such as a cover coat, varnish, cover layer, cover films, dielectric coatings, electrolytes and other electrically conductive materials, and the like. There may also be one or more materials between the substrate and printed circuits/sensors. Layers of printed electronic device 119 may include semiconductors, metal foils, and dielectric materials. Printed electronic device 119 may further include additional components, such as processors, memory chips, other microchips, batteries, resistors, diodes, capacitors, transistors, and the like.

Printed electronic device includes one or more copies of EMS 116 and/or ECS 118, wherein each sensor may include a unique design. Printed electronic device 119 can be formed in a manner to provide continuous and/or full-coverage monitoring of vessels. Printed electronic device 119 can be formed in an array on a substrate and deployed on the outside surface of above ground and/or subterranean vessels.

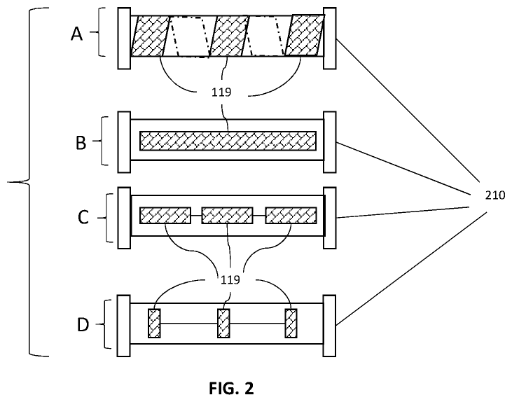

FIG. 2 illustrates deployment configurations of printed electronic devices, in accordance with an embodiment of the present invention. Configurations depicted in FIG. 2 are provided herein for illustration purposes only and are not meant to limit the number of applicable configurations in any manner. Specifically, FIG. 2 illustrates deployment configurations A, B, C and D, which depict a wrapped/wound, a longitudinal continuous, a longitudinal dis continuous, and a cross-axis configuration, respectively, of printed electronic device 119 affixed to the surface of vessel 210. Although not depicted, vessel 210 can include multiple uniform and/or non-uniform applications of printed electronic device 119 applied to its surface. Printed electronic device 119 may be applied to surfaces via tension wrappings or adhesives.

In this manner, metal vessels can operate as the magnetic core for the inductor (EM transmitter) during EM imaging (discussed below). The placement of printed electronic device 119 on the surface of vessels, such as vessel 210, allows for an improvement in the spatial resolution of the exploration map around the vessel's casing. Printed electronic device 119, which can include an array of EMS 116 and/or ECS 118 sensors (discussed below), can be wrapped around the surface of a vessel during installation and/or maintenance, wherein each sensor can be addressable independently. Printed electronic device 119 can be formed as a tape and/or film that includes one or more EMS 116 and ECS 118 units. Printed electronic device 119 may be formed directly on the vessel itself.

EMS 116 is a sensor that can monitor surface integrity and/or the environment proximate to a surface via electromagnetic (“EM”) imaging. EM imaging takes advantage of the differences in how EM fields are induced within various materials. The method measures electrical resistivity—or conversely, conductivity—of different materials to EM fields and waves. For example, measuring electrical resistivity near an oil well is a longstanding technique in oil exploration and mapping geologic strata. Such measurements are typically made out to about a meter around the well. Measurements of resistivity variations in the surrounding environment of a surface that is located underground can be used to optimize oil and gas well management. In the same vein, changes in pH, detection of chemical reactivity or corrosion, and the detection of specific electrochemically active aromatic hydrocarbons that are present in crude oil may be used to ascertain the presence of leaks, spillage, and/or corrosion. In an embodiment, printed electronic device 119 is formed as a tape/film at least one meter in length having a radius of curvature of about 0.5 mm to about 144 inches and also possessing sufficient flexibility to be wrapped or applied around curved surfaces.

Printed electronic device 119 can be formed in a manner to survive one or more of temperatures of 0-125° C., pressures up to 6,000 psi, pH from 6.5-8.5 (max of 12.5), and a salinity up to 100,000 ppm. Printed electronic device may be formed in a manner to include 30-60 sensors per m². The application of printed electronic device 119 on the outer surface of vessels can allow for direct measurement of changes to the soil/environment surrounding the vessels. The close proximity can provide limited signal attenuation as well as a large range of measuring frequencies for high resolution geo-imaging, for example, frequencies beyond the megahertz range. Printed electronic device 119 may be formed in a manner to have a low profile that facilitates deployment. In an embodiment, printed electronic device 119 can be formed as a flexible, large-area pipe wrap. Printed electronic device 119 may be formed in a manner to include multiple sensors, such as, sensors the detect/measure pH, salinity, soil moisture content, and particular hydrocarbons.

EMS 116 can be formed as a low-profile array of EM transmitter and receiver antennas suitable for EM imaging of the proximate area/environment surrounding the vessel. EMS 116 may be formed in a manner to provide EM resistivity imaging with reduced signal attenuation. EM resistivity imaging is a technique applied for hydrocarbon exploration and reservoir management. EM resistivity takes advantage of tomographic imaging of conductivity changes underground often using EM radiation with a frequency typically between about 1 Hz and about 30 YHz.

EMS 116 include transmitters (“transmitter”) and receivers (“receivers”), which may be formed using the previously discussed inks and/or coatings. The transmitters are inductors that provide an EM wave source and the receivers measure the total magnetic field reaching the vessel. Receivers receive the superposition of the EM wave sent out by transmitters and scattered waves from disturbance in the conductivity of the geological formation between the transmitter and the receiver, which provide a conductivity image of the proximate area/environment. For example, vessels, such as production wells, are typically stabilized by a well casing consisting of up to 50 cm diameter steel tubes with a wall thickness between 5 and 20 mm that is cemented into the freshly drilled well before production can commence.

The metal tube is known to have an attenuating impact on EM exploration. Depending on the magnetic properties of the steel used, for example, martensitic steels can exhibit relative permeability between 1 and 100, the penetration depth at 1 kHz ranges between 0.5 and 5 mm. The penetration depth at 1 kHz is the distance over which the EM wave drops by 1/e. Consequently, a 5 mm thick sheet can prohibit the transmission of EM radiation with frequencies in excess of 10 kHz. However, placement of the transmitter and receiver on the outside of the steel casing can provide a reduction of EM attenuation as well as an extension of the available frequency range, for example, up to radar frequencies. Such a solution can avoid the need to penetrate several millimeters of steel casing.

Printed electronic circuit 119 can include a plurality of EMS 116 units each having receivers of different designs and dimensions to optimize detection of specific frequencies. Receivers of differing geometries can be arrayed in alternating patterns along the length of the vessel such that EM signals of predetermined frequencies are detected along the length of the vessel. In an embodiment, printed electronic device 119 includes two or more EMS 116 units having receivers that are targeted at two or more differing frequency ranges.

ECS 118 is a sensor that may be formed using the above inks and/or coatings. ECS 118 provides direct sensing of the environment of the vessel, for example, to probe changes in the soil chemistry and identify leaks as well as corrosion events. ECS 118 provides continuous monitoring by electrochemical or catalytic sensing, which does not require that discrete samples be brought into a defined sample space nor the use of infrared detection or catalytic combustion. ECS 118 can detect changes in the conductivity of the functionalized graphene elements included therein due to binding/interactions with target molecules or due to catalytic reactions with target molecules. For example, the conductivity of an array of ECS 118 units can be read out along several different axes to provide greater accuracy and reliability under changing environmental conditions.

ECS 118 can also detect the ionic resistivity of the surrounding environment between two electrodes included therein, which is used to ascertain changes in soil moisture content and salinity levels. To facilitate the aforementioned detection, ECS 118 may be formed in a manner to bridge electrode elements with polyelectrolyte layers included in printed electric device 119 to maintain an ionically conductive path between two electrodes. For example, monitoring of salinity in the proximate area/environment around the vessel allows for the prediction of corrosion rates at localized points along the vessels, which can thereby enable the proper adjustment of anti-corrosion measures.

ECS 118 detects electrochemically active components of crude oil, which can be used to detect early-stage leaks. Applicable electrochemically active components of crude oil include aromatic hydrocarbons, such as nepthalene, phenanthrene, and benzopyrene, which show specific absorption to graphene. ECS 118 measures electrical conductivity between nodes, which correlates to changes in the vessel's environment. In embodiment, ECS 118 include inks and/or coatings that absorb and/or swell as a result of changes in pH level, ionic strength, and/or absorbing oil. ECS 118 can include two or more electrodes (“electrodes”) that are interconnected by an ionically conducting polyelectrolyte material.

Applicable polyelectrolyte material includes polyacrylic acid and sodium alginate. The ionic resistance between two adjacent electrodes can be used as an indicator of pH level, salinity, and/or soil moisture. Ionic resistance can be measured using impedence or voltammetry techniques to ascertain polyelectrolyte conductivity changes as a function of environmental conditions. ECS 118 can employ absorptive stripping voltammetry to directly sense oil leaks in the proximate area/environment of the vessel.

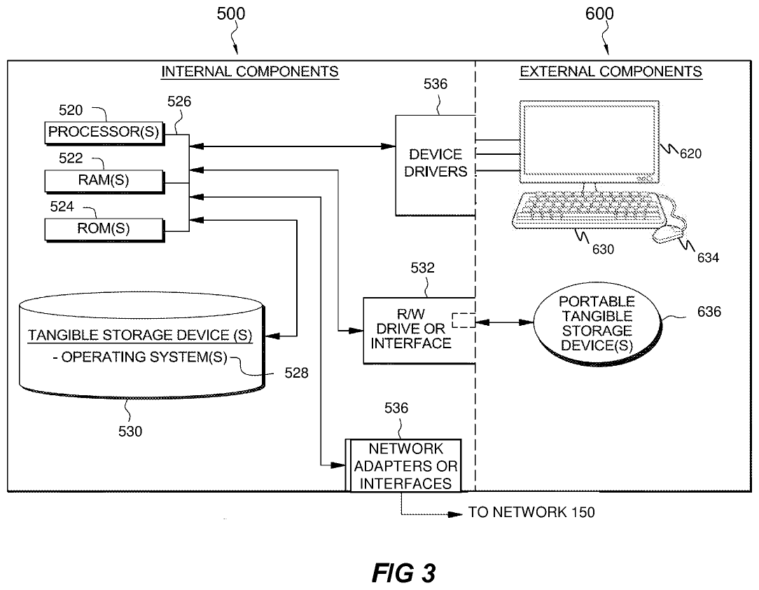

FIG. 3 depicts a block diagram of the components of a computing device 110, in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 500, 600 is representative of any electronic device capable of executing machine-readable program instructions. Data processing system 500, 600 may be representative of a smart phone, a computer system, PDA, or other electronic devices. Examples of computing systems, environments, and/or configurations that may be represented by data processing system 500, 600 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

Computing device 110 includes respective sets of internal components 500 and external components 600 illustrated in FIG. 3. Each of the sets of internal components 500 includes one or more processors 520, one or more computer-readable RAMs 522 and one or more computer-readable ROMs 524 on one or more buses 526, and one or more operating systems 528 and one or more computer-readable tangible storage devices 530. Program function 112 in computing device 110 is stored on one or more of the respective computer-readable tangible storage devices 530 for execution by one or more of the respective processors 520 via one or more of the respective RAMs 522 (which typically include cache memory). In the embodiment illustrated in FIG. 3, each of the computer-readable tangible storage devices 530 is a magnetic disk storage device of an internal hard drive. Alternatively, each of the computer-readable tangible storage devices 530 is a semiconductor storage device such as ROM 524, EPROM, flash memory or any other computer-readable tangible storage device that can store a computer program and digital information.

Each set of internal components 500 also includes a R/W drive or interface 532 to read from and write to one or more portable computer-readable tangible storage devices 636 such as a CD-ROM, DVD, memory stick, magnetic tape, magnetic disk, optical disk or semiconductor storage device. Program function 112 can be stored on one or more of the respective portable computer-readable tangible storage devices 636, read via the respective R/W drive or interface 532 and loaded into the respective computer-readable tangible storage devices 530.

Each set of internal components 500 also includes network adapters or interfaces 536 such as TCP/IP adapter cards, wireless Wi-Fi interface cards, or 3G or 4G wireless interface cards or other wired or wireless communication links. Program function 112 can be downloaded to computing device 110 from an external computer via a network (for example, the Internet, a local area network or other, wide area network) and respective network adapters or interfaces 536. From the network adapters or interfaces 536, program function 112 is loaded into the respective computer-readable tangible storage devices 530. The network may comprise copper wires, optical fibers, wireless transmission, routers, firewalls, switches, gateway computers and/or edge servers.

Each of the sets of external components 600 can include a computer display monitor 620, a keyboard 630, and a computer mouse 634. External components 600 can also include touch screens, virtual keyboards, touch pads, pointing devices, and other human interface devices. Each of the sets of internal components 500 also includes device drivers 540 to interface to computer display monitor 620, keyboard 630 and computer mouse 634. The device drivers 540, R/W drive or interface 532 and network adapters or interfaces 536 comprise hardware and software (stored in storage device 530 and/or ROM 524).

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, though the Internet using an Internet Service Provider).

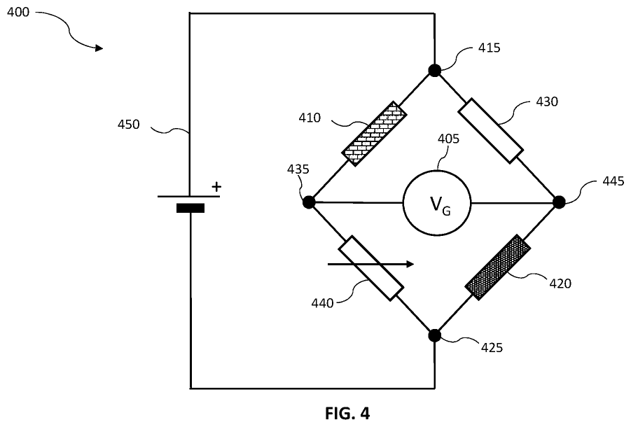

FIG. 4 depicts a microsensor, generally 400, in accordance with an embodiment of the present invention. Microsensor 400 can be a catalytic microsensor that utilizes metal or metal-oxide nanoparticles that are affixed to graphene sheets to increase the amount of atoms, molecules, and/or ions absorbed and/or catalyze the decomposition thereof. For example, microsensor 400 can be configured to absorb methane and/or catalyze the decomposition of methane. Microsensor 400 can be a printed electronic device. Applicable atoms, molecules, and/or ions can include, but are not limited to, those that comprise chemicals, bodily fluids, water, fluids, methane as well as aromatic hydrocarbons, such as nepthalene, phenanthrene, and benzopyrene. In certain embodiments, microsensor 400 can perform similar functions as and/or include similar component that are included in EMS 116 and/or ECS 119. Microsensor 400 can comprise a Wheatstone bridge having power source 450, galvanometer 504, as well as resistors 410, 420, 430, and 440.

Resistor 410 is in electrical communication with resistors 440 and 430 via nodes 435 and 415, respectively. Resistor 420 is in electrical communication resistors 440 and 430 via nodes 425 and 445. Galvanometer 405 is in electrical communication with nodes 435 445. Resistors 410, 420, 430, and/or 440 may be comprised of graphene, such as graphene sheets and/or the graphene with nanoparticles (discussed above) affixed thereto. For example, resistors 410, 420, 430, and 440 can be formed by printing a graphene-based conductive composition. Resistor 420 can be a sampling resistor that contains nanoparticles that are affixed to the graphene that is included therein, wherein the nanoparticles bind to particular atoms, molecules, and/or ions.

Resistor 410 can be a standard resistor having graphene that lacks the nanoparticles. Variations in the resistance of the sampling arm, resistors 430 and 420, are caused by the absorption of particular atoms, molecules, and/or ions on resistor 420. The sensitivity of microsensor 400 may be increased by raising the operating temperature of microsensor 400 to the decomposition temperature of the chemical. Microsensor 400 can detect a leak of about 6 scfh (2.83 L/min) or greater. Microsensor 400 can operate in a temperature range of about −20 to about 400° C. or less, a humidity range of about 10-100% RH, as well as various ranges included therein.

For example, if resistor 440 is adjustable and the resistance of resistors 410 and 440 (which are both known) equals the resistance of resistors 430 and 420, then the voltage between nodes 435 and 445 will be zero and no current will flow through galvanometer 405. However, the absorption of predetermined atoms, molecules, and/or ions on to resistor 420 changes its resistance, which reflects that the Wheatstone bridge is imbalanced and current is flowing through galvanometer 405. Here, the direction of the current flowing through galvanometer 405 will indicate whether the resistance of resistor 420 is above or below its normal resistance.

In another example, if the resistance of resistor 440 is not adjustable, the voltage difference across or current flow through galvanometer 405 can be utilized to calculate the resistance of resistor 420 using, for example, Kirchhoff's circuit laws.

In an additional example, the decomposition of a molecule, for example, methane, on resistor 420 can release heat, which can increase the temperature of resistor 420 with respect to that of resistor 410, which can act as a reference, and the resulting change in the resistance of microsensor 400 is proportional to the amount of methane present on resistor 420. In further embodiments, the amount of heat released may also be sufficient to consume resistor 420, resulting in an open circuit that indicates the presence of the desired atoms, molecules, and/or ions. For example, microsensor 400 can be configured to detect at least about 1 to about 60 ppm of a molecule, such as methane, that is located approximate thereto. Power source 450 may be utilized to maintain the temperature of microsensor 400 to achieve the desired sensitivity on low temperature weather. Microsensor 400 can be included in a sensor apparatus, which is wrapped around or affixed to a surface. Multiple copies of microsensor 400 can be included in a sensor array that is in electrical communication with a databus, which may be in further electrical communication with a transponder, such as radio frequency (“RF”) transponder.

For example, the RF transponder can subsequently transmit data that is generated by sensor array to a transceiver for subsequent analysis and/or notification, for example, by one or more distributed control systems or supervisory control and data acquisition systems (“SCADA”).

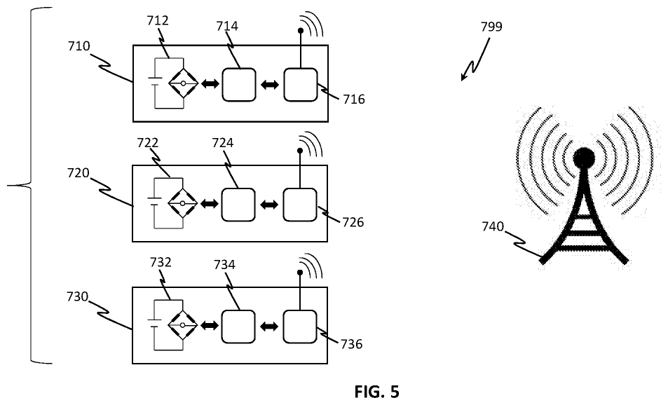

FIG. 5 depicts an environment, generally 799, in accordance with an embodiment of the present invention. Environment 799 includes sensor nodes 710, 720, and 730 that can communicate with transceiver 740. Sensor nodes 710, 720, and 730 are sensors that can detect, measure, sense, and/or monitor predetermined atoms, molecules, and/or ions. Sensor nodes 710, 720, and 730 includes microsensors 712, 722, and 732, respectively. Microsensors 712, 722, and 732 can include similar components and/or perform similar functions as microsensor 400 (discussed above). Microsensors 712, 722, and 732 can sense, detect, and/or monitor similar or different atoms, molecules, and/or ions. For example, microsensors 712, 722, and 732 can be configured to detect alkanes and/or additional components of thermogenic gases, such as C2 to C5 alkanes and higher molecular weight hydrocarbons, H₂S, CO₂, and/or water vapor. Sensor nodes 710, 720, and 730 can be included in a multilayer sensor array system, wherein thermogenic and/or biogenic differentiation are performed. Microsensors 712, 722, and 732 can be included in a sensor array that is applied/affixed to a surface. Sensor nodes 710, 720, and/or 730 can communicate with remote terminal units in order to interface with distributed control systems or SCADA systems.

Sensor nodes 710, 720, and 730 include control units 714, 724, and 734 with are in data and/or electrical communication with microsensors 712, 722, and 732, respectively. Control units 714, 724, and 734 can be printed electronic devices or comprise printed electronics. Control units 714, 724, and 734 can interface with sensors and/or communication units, such as communication units 716, 726, and 736, to communicate information/data generated by microsensors 712, 722, and 732, respectively. Control units 714, 724, and/or 734 can perform similar function as and/or include similar components that are included in computing device 110. Control units 714, 724, 734 can provide continuous, periodic, and/or real-time analysis of information that is generated by sensor nodes 710, 720, and 730, respectively.

For example, control units 714, 724, and/or 734 can measure the differences in resistivity caused by the absorption and/or catalytic decomposition of atoms, molecules, and/or ions that are affixed to the nanoparticles in that are included microsensors 712, 722, and 732, respectively.

Communication units 716, 726, and 736 are electronic devices that can utilize communication protocols to exchange information with other computing devices.

Communication units 716, 726, and 736 are in information and/or electrical communication with control units 714, 724, and 734, respectively. Communication units 716, 726, and 736 can utilize applicable wired and/or wireless methods for communications. Communication units 716, 726, and 736 can use the TCP/IP protocol for communications. Communication units 716, 726, and 736 can communicate with transceiver 740 via any applicable wired and/or wireless protocol, such as cellular or long distance wireless. Transceiver 740 can be in electrical and/or information communication with a SCADA system for one or more uses, including, but not limited to, control of remote equipment, data analysis, and asset monitoring. Transceiver 740 can be included in network 130.

For example, one or more copies of sensor nodes 710, 720, and/or 730 can be included in sensor array tapes or wraps and affixed to well pad components, such as on the surface of posts that can be located on the periphery of the well pad. Such an arrangement may mitigate or eliminate the need for wind speed and direction indicators, which can potentially permit the approximation of leak locations and the estimation of leakage rates by variations in sensor readings throughout the array. To minimize and/or avoid the reporting of false positive alarms, the resistivity of sensor elements across well pad can be continuously monitored. Appropriate network algorithms can be utilized to analyze the signals that are received from the sensor nodes in order to distinguish transient from continuing events.

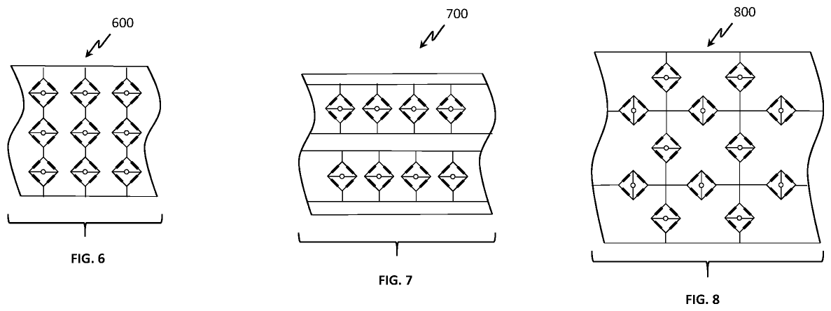

FIG. 6 depicts a portion of a sensor array, generally 600, in accordance with an embodiment of the present invention. Specifically, FIG. 6 illustrates a portion of a sensor array. Sensor array 600 is an array having a plurality microsensors, such as microsensor, that are arranged in series. FIG. 7 depicts a portion of a sensor array, generally 700, in accordance with an embodiment of the present invention. Specifically, FIG. 7 illustrates a portion of a sensor array. Sensor array 600 is an array having a plurality microsensors, such as microsensor, that are arranged in parallel. FIG. 8 depicts a portion of a sensor array, generally 800, in accordance with an embodiment of the present invention. Specifically, FIG. 8 illustrates a portion of a sensor array. Sensor array 800 is an array having a plurality microsensors, such as microsensor, that are arranged in mesh formation.

Based on the foregoing, a printed electronic device and method have been disclosed in accordance with the present invention. However, numerous modifications and substitutions can be made without deviating from the scope of the present invention. Therefore, the present invention has been disclosed by way of example and not limitation.

What is claimed is:

1. A Wheatstone bridge device, comprising:
a first resistor positioned proximate to a surface of the substrate and comprising a conductive composition, the conductive composition comprising fully exfoliated single sheets of graphene and a polymer; and
wherein
the first resistor undergoes a conductivity change as a result of binding to a target component; and
the fully exfoliated single sheets of graphene display no signature corresponding to graphite or graphite oxide in their X-ray diffraction pattern.

2. The Wheatstone bridge device of claim 1, wherein the conductive composition further comprises one or more of a metal and a metal oxide that binds to one or more of a predetermined atom, a predetermined ion, and a predetermined molecule.

3. The Wheatstone bridge device of claim 1, wherein the conductive composition further comprises one or more of a metal coated material and a metal-oxide coated material that bind to one or more of a predetermined atom, a predetermined ion, and a predetermined molecule.

4. The Wheatstone bridge device of claim 1, wherein the fully exfoliated single sheets of graphene comprise epoxy functional groups.

5. The Wheatstone bridge device of claim 1, further comprising:
a second resistor comprising a second conductive composition; and
wherein the second conductive composition comprises fully exfoliated single sheets of graphene and a second polymer.

6. A sensor array wrapping, comprising:
a plurality of the Wheatstone bridge devices of claim 1 arranged in an array and positioned proximate to a surface of a substrate; and
wherein the substrate is configured to be applied to a surface of a vessel in one of a wound configuration, a longitudinal configuration, a longitudinal discontinuous configuration, and a cross-axis configuration.

7. The sensor array wrapping of claim 6, further comprising:
a transceiver communicatively coupled to the plurality of the Wheatstone bridge devices;
a first control circuit communicatively coupled to the transceiver; and
wherein the first control circuit is configured to communicate, via the transceiver, with a second control circuit.

8. The sensor array wrapping of claim 7, wherein the control circuit is configured to:
capture, via the plurality of the Wheatstone bridge devices of claim 1, sensor data; and
identify, using the captured sensor data, a location on the vessel of a leak.

9. The sensor array wrapping of claim 6, wherein the substrate comprises a radius of curvature of about 0.5 mm to about 144 inches.

10. A sensor array wrapping, comprising:
a plurality of the Wheatstone bridge devices of claim 1 arranged in an array and positioned proximate to a surface of a substrate, the substrate configured to be applied to a surface of a vessel in one of a wound configuration, a longitudinal configuration, a longitudinal discontinuous configuration, and a cross-axis configuration;
a transceiver communicatively coupled to the plurality of the Wheatstone bridge devices;
a first control circuit communicatively coupled to the transceiver; and
wherein the control circuit is configured to
communicate, via the transceiver, with a second control circuit external to the sensor array wrapping;
capture, via the plurality of the Wheatstone bridge devices of claim 1, sensor data; and
identify, using the captured sensor data, a location of a leak on the surface

11. The sensor array wrapping of claim 10, wherein the fully exfoliated single sheets of graphene comprise epoxy functional groups.

12. The sensor array wrapping of claim 10, wherein each Wheatstone bridge device of the plurality of Wheatstone bridge devices further comprises:
a second resistor communicatively coupled to the first resistor and comprising a second conductive composition; and
wherein the second conductive composition comprises fully exfoliated single sheets of graphene and a second polymer.

13. The sensor array wrapping of claim 10, wherein the substrate is configured to be applied to the surface of the vessel via an adhesive.

14. The sensor array wrapping of claim 10, wherein the substrate comprises a radius of curvature of about 0.5 mm to about 144 inches.

15. The sensor array wrapping of claim 10, wherein the substrate is configured to be applied to the surface of the vessel via a tension wrapping.
